(19) United States
(12) Patent Application Publication
(10) Pub. No.: US 2020/0248014 A1
(43) Pub. Date: Aug. 6, 2020

(54) THERMALLY CONDUCTIVE POLYMER BASED FILAMENT

(71) Applicant: TCPoly, Inc., Atlanta, GA (US)

(72) Inventors: Thomas Lloyd Bougher, Atlanta, GA (US); Matthew Kirby Smith, Atlanta, GA (US)

(21) Appl. No.: 16/852,521

(22) Filed: Apr. 19, 2020

Related U.S. Application Data
(63) Continuation of application No. PCT/US2018/056315, filed on Oct. 17, 2018.
(60) Provisional application No. 62/574,521, filed on Oct. 19, 2017.

(51) Int. Cl. C09D 11/037; C09D 11/102; C09D 11/104; C09D 11/108; C09D 11/107; B33Y 40/10; B33Y 70/10; B29C 64/314; B29B 7/90; B29B 9/12; B29B 11/10; F28F 21/06

(52) U.S. Cl. CPC C09D 11/037; C09D 11/102; C09D 11/104; C09D 11/108; C09D 11/107; F28F 21/067; B33Y 70/10; B29C 64/314; B29B 7/90; B29B 9/12; B29B 11/10; B33Y 40/10

(57) ABSTRACT

In order to provide a thermally conductive polymer based filament that may be printed using additive manufacturing techniques, a composition includes a thermoplastic polymer and/or elastomer that is soft and pliable, a polar polymeric thermoplastic, and a thermally conductive filler. The composition includes from 15 to 80 weight percentage of a thermoplastic polymer and/or a thermoplastic elastomer, from 20 to 85 weight percentage of a thermally conductive filler, and from 0 to 25 weight percentage of a thermoplastic polymer having polarity on a main chain of a molecule that results in a dipole moment. The thermoplastic polymer and/or the thermoplastic elastomer has a combined Notched Izod impact strength greater than or equal to 300 J/m and a flexural modulus less than 3 GPa. The filler has an intrinsic thermal conductivity greater than or equal to 1 W/m-K. The composition is characterized by a thermal conductivity of at least 0.75 W/m-K and an Izod notched impact strength of at least 100 J/m.

### PRIORITY

This application is a continuation of PCT/US2018/056315, filed Oct. 17, 2018, which claims the benefit of U.S. Provisional Patent Application No. 62/574,521, filed Oct. 19, 2017. The entire contents of these documents are hereby incorporated herein by reference.

### BACKGROUND

Thermal management of electronic devices is a burgeoning challenge due to increased power consumption and reduced weight and size requirements for the electronic devices, which ultimately result in high power density. In addition, most established consumer electronic industries are very cost competitive due to outsourcing and materials cost minimization efforts. Plastics are cheaper to manufacture than metals because of the ease of processing, but use of plastics is often limited due to poor thermal conduction, which results in thermal management inadequacies.

In order to fill the demand for cheap plastic materials with high thermal conductivity, a number of commercial suppliers make polymer composite materials filled with thermally conductivity particles to create a bulk composite that may be processed similarly to traditional plastics (e.g., injection molded, compression molded, etc.). While these materials are gaining in popularity, one thing limiting adoption of these materials is the cost and time to prototype. Creating prototypes through molding methods typically requires intricate mold tooling that is expensive and time consuming. Additionally, most molding processes have geometry limitations due to mold filling and part ejection considerations that often dictate relatively low aspect ratio features compared to what is optimal from a heat transfer perspective (e.g., fins on a heat sink).

Additive manufacturing (e.g., three-dimensional (3D) printing) is used for rapid prototyping in many areas, but currently, there are no plastics suitable for additive manufacturing methods with high enough thermal conductivity for thermal management prototyping or production parts. This is due to the high filler content (e.g., >25 weight percentage) added to common plastics such as, for example, acrylonitrile butadiene styrene (ABS), polycarbonate (PC), Nylon (PA), polyphenylene sulfide (PPS) and polystyrene (PS) rendering the composite unsuitable for creating filaments for fused deposition modeling (FDM) or additive manufacturing in general. The high filler loadings make the filaments too brittle to be processed using traditional filament manufacturing techniques, result in poor bed adhesion, and result in nozzle blockage, abrasion, and clogging. The common filament materials used in FDM printing, ABS and polylactic acid (PLA), may only tolerate low levels of fillers (e.g., <20 weight percentage) before becoming too brittle for many 3D printers.

Additive manufacturing is a rapidly growing technology that allows for rapid prototyping and manufacturing of plastic and metal parts. FDM is the simplest 3D printing technique, in which moderately high resolution and quality parts may be obtained with even low-cost consumer printers. FDM 3D printers melt and extrude polymer filaments to produce 3D objects through layer by layer deposition. Polymer filaments are typically composed of base thermoplastic material ABS, PLA, PC, Nylon (PA), polyetherimide (PEI), polyether ether ketone (PEEK), polyethylene terephthalate (PET), thermoplastic polyurethane (TPU), or some combination thereof. Commercially available FDM 3D printing composites are also available and typically include carbon fiber, glass, or metal fillers.

### SUMMARY AND DESCRIPTION

The scope of the present invention is defined solely by the appended claims and is not affected to any degree by the statements within this summary.

In order to provide a thermally conductive polymer based filament that may be printed using additive manufacturing techniques, a composition includes a thermoplastic polymer and/or elastomer that is soft and pliable, a polar polymeric thermoplastic, and a thermally conductive filler.

In a first aspect, a composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a polar thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The thermally conductive filler includes aluminum nitride (AlN), boron nitride (BN), BN nanotubes, thermally conductive polymer particles, thermally conductive polymer fibers, thermally conductive polymer flakes, MgSiN2, silicon carbide (SiC), graphite, ceramic-coated graphite, expanded graphite, carbon fibers, carbon nanotubes, graphene, metal wires, or any combination thereof. The composition is characterized by a thermal conductivity of at least 0.75 W/m-K.

In a second aspect, a method for manufacturing a thermally conductive filament includes forming thermally conductive polymer-pellets, melting the thermally conductive polymer pellets, and extruding the melted thermally conductive polymer-pellets into circular filament with a predetermined diameter. The thermally conductive polymer-based pellets include a polar thermoplastic, a thermoplastic matrix, and a thermally conductive filler.

In a third aspect, a method for manufacturing a thermally conductive component includes additive manufacturing the thermally conductive component using a thermally conductive filament. The thermally conductive filament is made of a composition. The composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a polar thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The composition is characterized by a thermal conductivity of at least 0.75 W/m-K and a Notched Izod impact strength of at least 100 J/m.

In a fourth aspect, a thermally conductive additive manufacturing filament includes a composition. The composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a polar thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The thermally conductive filler includes aluminum nitride (AlN), boron nitride (BN), BN nanotubes, thermally conductive polymer fibers, silicon carbide (SiC), graphite, ceramic-coated graphite, expanded graphite, carbon black, carbon fibers, carbon nanotubes, graphene, metal wires, or any combination thereof. The composition is characterized by a thermal conductivity of at least 0.75 W/m-K.

### BRIEF DESCRIPTION OF THE DRAWINGS

For a more complete understanding of the disclosure, reference is made to the following detailed description and accompanying drawing figures, in which like reference numerals may be used to identify like elements in the figures.

FIG. 1 is a flow diagram of one embodiment of a method for manufacturing a thermally conductive three dimensional (3D) printing filament;

FIG. 2 shows the relationship between filament flexibility and thermal conductivity;

FIG. 3 illustrates the behavior of a filament having a correct stiffness for 3D printing;

FIG. 4 illustrates the behavior of a filament that is too flexible for 3D printing;

FIG. 5 illustrates the behavior of a filament that is too brittle for 3D printing;

FIG. 6 illustrates the behavior of a filament that is too brittle for spooling and/or has an insufficient bend radius; and

FIG. 7 is a flow diagram of one embodiment of a method for manufacturing a thermally conductive component.

While the disclosed devices, systems, and methods are representative of embodiments in various forms, specific embodiments are illustrated in the drawings (and are hereafter described), with the understanding that the disclosure is intended to be illustrative, and is not intended to limit the claim scope to the specific embodiments described and illustrated herein

### DETAILED DESCRIPTION

Thermally conductive polymers (TCPs) have emerged as a new class of materials that may be used for thermal management and heat dissipation challenges. Thermally conductive plastics may be lightweight and low-cost in comparisons to metals. A need exists for thermally conductive polymer based filaments that may be printed using additive manufacturing techniques such as FDM. Through additive manufacturing, engineers and designers may rapidly prototype with thermally conductive polymers to develop new products at a reduced cost and time. High volume contents of filler, however, are needed to achieve thermal conductivities suitable for efficient heat transport through a polymer composite, and filaments with high volume content are difficult to print and spool because of brittleness of the filament, nozzle clogging and abrasion, and poor bed adhesion after nozzle extrusion.

One or more of the present embodiments provide a filament composition that may achieve high thermal conductivity when printed using traditional FDM printing technologies, exhibits good bed adhesion to the 3D printing substrate, and is not brittle and will not break during the spooling and printing process. In the present embodiments, electrically conducting and electrically insulating filaments with thermal conductivities up to 20 W/m-K and 10 W/m-K, respectively, may be produced. The electrical properties are dictated by the filler type and weight percentage loading, where, for example, oxide, nitride, and polymer based fillers are electrically insulating and result in insulating composites, and metal, carbide, carbon fiber, graphene, graphite, and carbon nanotube based fillers are electrically conducting and result in electrically conducting composites.

The thermal conductivity of the plastics can be measured using the laser flash method (ASTM E1461). The laser flash method directly measures thermal diffusivity, where the thermal conductivity may be calculated through a calibrated laser flash sample or through independent measurement of the density and specific heat of the sample. The thermal conductivity values referred to herein are the maximum thermal conductivity values achieved by the material, which may have different values in different orientations.

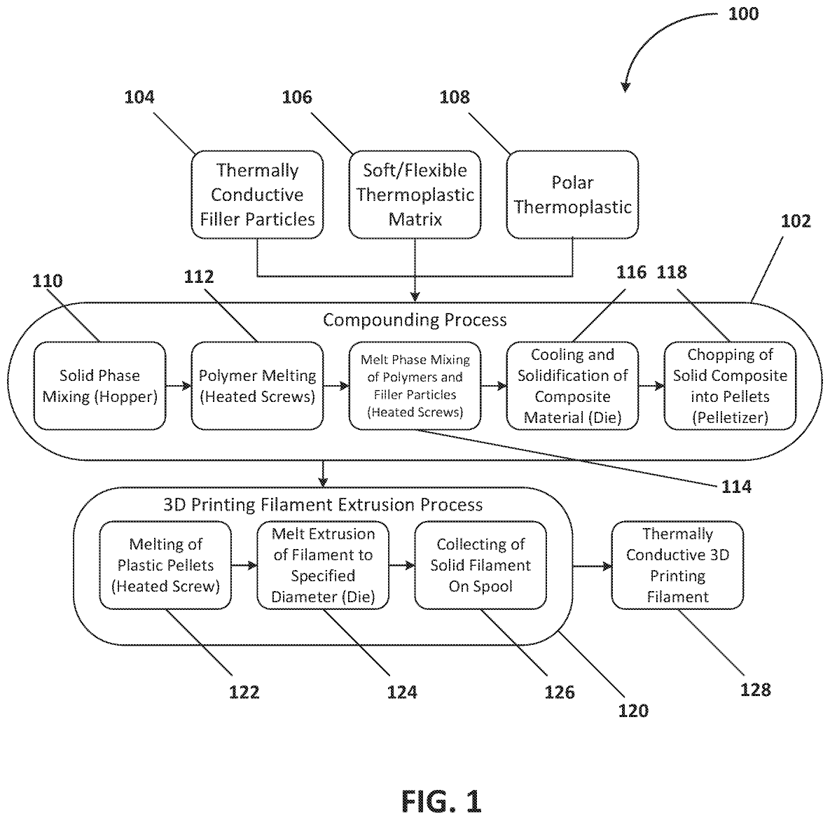

FIG. 1 shows a flowchart of one example of a method 100 for manufacturing a thermally conductive polymer-based additive manufacturing filament. The method 100 is implemented in the order shown, but other orders may be used. Additional, different, or fewer acts may be provided. Similar methods may be used for manufacturing a thermally conductive polymer based additive manufacturing filament.

In act 102, thermally conductive polymer based pellets are formed. As shown in FIG. 1, in one embodiment, the thermally conductive polymer based pellets are formed from a composite material including a thermally conductive filler 104 (e.g., thermally conductive particles), a soft/flexible thermoplastic matrix 106, and a polar thermoplastic 108. One or more types of thermally conductive filler particles, one or more types of thermoplastic matrix, and/or one or more types of polar thermoplastics may be included in the composite material.

Any number of different types of thermally conductive fillers 104 may be used. For example, a thermally conductive filler 104 having an intrinsic thermal conductivity greater than or equal to 1 W/m-K is used. The thermally conductive filler 104 may include, for example, aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic-coated graphite, expanded graphite, carbon fibers, carbon nanotubes, graphene, metal wires, carbon black, another thermally conductive filler, or any combination thereof. The thermally conductive filler may take any number of forms including, for example, as an AlN spherule, a polymer fiber, an SiC particle, a BN flake, a BN nanotube, a graphite flake, an expanded graphite particle, a carbon black particle, a carbon fiber, a carbon nanotube, a graphene nanoplatelet, a metal spherule, a metal wire, or any combination thereof.

The thermoplastic matrix 106 includes thermoplastic polymers and/or elastomers that are soft and pliable, as defined by having high impact strength, hardness at or below shore 80A, and low flexural modulus below 3 GPa or 1 GPa. These thermoplastics allow high filler loading in the filament without filament breaking (e.g., brittleness is minimized) during printing or spooling, a known challenge for 3D printing heavily filled composite materials. The thermally conductive filler particles 104 may be smaller than a particular size (e.g., 0.3 mm) in all dimensions except one to prevent nozzle clogging and to maintain a good viscosity for flow through FDM nozzles (e.g., 0.4 mm to greater than 1.0 mm in the one dimension for these applications). In one embodiment, the thermally conductive filler particles 104 are below 0.3 mm, for example, in all dimensions. Other maximum sizes may be provided (e.g., in all or less than all dimensions). High aspect ratio one dimensional (1D) structures may align and move through the nozzle without clogging, which further enhances thermal conductivity of the printed material, as heat typically moves most efficiently along the long axis of high aspect ratio fillers such as, for example, carbon fibers or highly oriented polymer fibers.

In one embodiment, the thermoplastic polymers and/or elastomers include thermoplastic polymers such as, for example, an aliphatic polyamide, polystyrene, polyester, polypropylene, polyphenylene sulfide, polycarbonate, polyolefin, polyurethane, polyetherimide, or any combination thereof. In one embodiment, alternatively or in combination, the thermoplastic polymers and/or elastomers include elastomers such as, for example, polyurethanes, copolyesters, olefins, styrenic block copolymers, elastomeric alloys, polyamides, or any combination thereof.

The polar thermoplastic 108 is polar in that a covalent bond between two atoms is provided and the electrons form a dipole moment; this dipole moment is repeated along a chain backbone of the polar thermoplastic 108. The polar thermoplastic 108 may be a polymeric thermoplastic such as, for example, a biopolymer (PLA, PCL, etc.) or other polar species such as ABS, PC, PA, or Poly(methyl methacrylate) (PMMA). In one embodiment, the polar thermoplastic 108 includes a polyamide, polycarbonate, ABS, acrylic styrene acrylonitrile, PMMA, polyester, PA, thermoplastic elastomer or any combination thereof. The polar thermoplastic 108 may be included in the composite material to improve filament bed adhesion during the printing process, which is also a known challenge to 3D printing highly filled composite materials. FDM printing may be done on polar glass surfaces, and the included polar thermoplastic 108 provides improved adhesion for the filament during the printing process compared to a filament that does not include a polar thermoplastic. Polymer blending also allows for control of brittleness and modulus of the resultant filament, and the technical specifications provided for flexural modulus, impact strength, and hardness provide guidance for selecting thermoplastic polymers and thermoplastic polymer blends that may be filled with high filler loading levels without resulting in a filament that is too brittle.

In one embodiment, the composite material also includes 0 to 15 weight percentage of additional functional additives. The additional functional additives include organic flame retardant, reinforcing fibers, plasticizers, compatiblizers, or any combination thereof. Other additives may be provided.

In one embodiment, the composite material is characterized by a tensile strength that is greater than or equal to 0.04 times the elastic modulus. In another embodiment, the composite material is characterized by a Notched Izod impact strength greater than or equal to 100 J/m. The tensile strength and elastic modulus may be measured using ASTM D638 and the Notched Izod impact strength may be measured using ASTM D256.

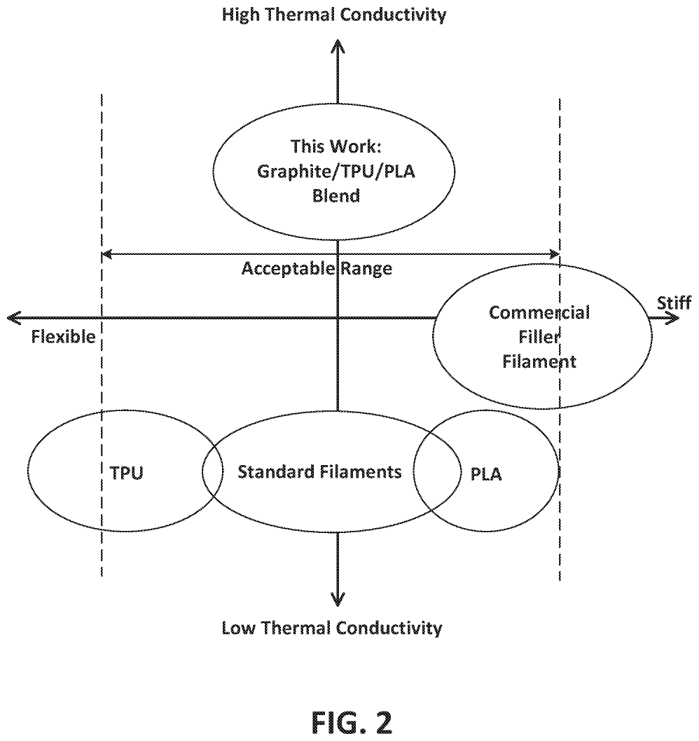

FIG. 2 shows the relationship between filament flexibility and thermal conductivity. Typically, when fillers are added to a filament of the prior art to increase thermal conductivity, this filament becomes too stiff and brittle for printing. By combining a flexible thermoplastic material 106 with fillers (e.g., the thermally conductive filler particles 104), a composite that is in an ideal range of flexibility for printing may be created. By adding small amounts of stiff PLA or PC, for example, the flexibility of the composite material and thus the pellets and the resultant filament may be tuned for 3D printing.

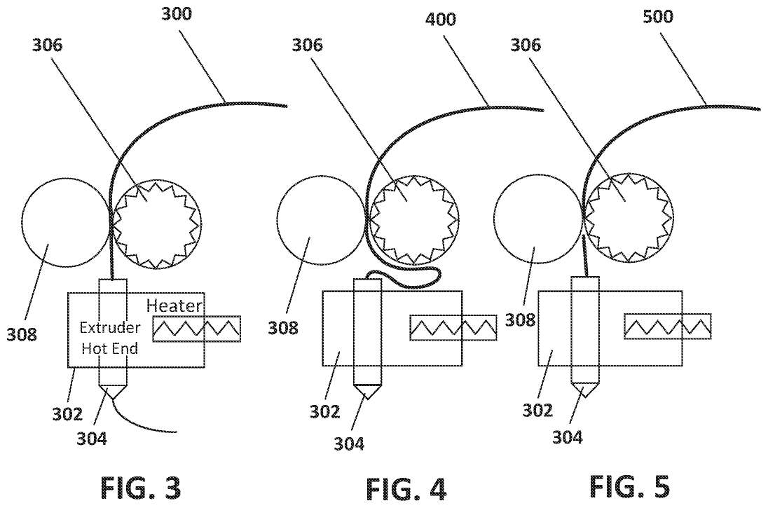

FIG. 3 illustrates the behavior of a filament 300 having a correct stiffness for 3D printing. The filament 300 is pushed through an extruder 302 and out a nozzle 304 by a motor gear 306 with the help of a bearing 308. For example, if 50 weight percent or 30 weight percent graphite is mixed with a blend of a TPU and PLA or PC, the resultant filament may be flexible enough to spool and stiff enough to be printed. The PLA or PC adds stiffness.

FIG. 4 illustrates the behavior of a filament 400 that is too flexible for 3D printing. The filament 400 buckles and winds up in the motor gear 306, preventing printing. For example, if 50 weight percent or 30 weight percent graphite is mixed into a TPU having a Shore Hardness of 95A or less (e.g., 70A), the resultant filament buckles and jams in many additive manufacturing systems.

A minimum elastic modulus may thus be targeted for the composite material. The maximum load an unsupported filament can withstand without buckling is:

$$F = \frac{{π}^{2} EI}{{( {KL}_{u} )}^{2}} \qquad ( 1 )$$

where E is the elastic modulus of the material, I is the moment of inertia, K is the effective length factor, and Lᵤ is the unsupported length. As an example, the load due to pushing the solid filament from the motor gear 306 into the melted state of a hot end of the extruder 302 with a 0.5 mm nozzle is assumed to be 50 N, the K factor is 2, the unsupported length is 5 mm, and the moment of inertia of a 1.75 mm diameter filament, for example, is 4.6×10⁻¹² m⁴. This provides a minimum elastic modulus of the filament to be 1 GPa to prevent buckling during printing. Assuming a factor of safety of two, for example, an elastic modulus of 2 GPa may be targeted for the filament. Rearranging this equation provides a critical buckling pressure as a function of key dimensions and filament properties:

$${P}_{cr} = \frac{π}{16} \frac{{Ed}^{2}}{{L}_{u}^{2}} \qquad ( 2 )$$

where d is the filament diameter. This pressure may be related to a pressure drop in the extruder hot end that may be approximated as a pressure drop in a capillary rheometer:

$$Δ {P}_{he} = \frac{8}{π} \frac{{QL}_{t} {η}_{e}}{{R}^{4}} \qquad ( 3 )$$

where ΔPₕₑ is the pressure drop in the hot end, Q is the volumetric flow rate, Lₜ is a length of melted plastic, ηₑ is the effective viscosity, and R is the radius of the cylinder in the hot end. To avoid buckling, P_{cr}>ΔPₕₑ is set, and P_{cr} and ΔPₕₑ are substituted in for from Equation 2 and Equation 3. Variables relating to the hot end and variables relating to the filament material are separated to provide the following buckling criteria:

$$\frac{E}{{η}_{e}} > \frac{32}{{π}^{3}} \frac{{QL}_{t} {L}_{u}^{2}}{{R}^{4} {d}^{2}} \qquad ( 4 )$$

The majority of thermoplastic composites that would be used in FDM printing would exhibit a shear thinning behavior, such that the viscosity is not constant and decreases with an increasing shear rate. This provides that the inequality in Equation 4 has different critical values depending on the extrusion nozzle diameter and flow rate. While the requirements for buckling may be relaxed through decreasing the volumetric flow rate (e.g., decreasing the printing speed) or increasing the printer nozzle diameter (e.g., decreasing the pressure drop), the intent is to provide that the filament will not buckle under standard print conditions (e.g., as a minimum). Experiments have shown that for a thermoplastic composite with graphite particles, the critical value of E/ηₑ is on the order of 10⁶ s⁻¹ for a 0.4 mm nozzle. For a thermoplastic composite with an effective viscosity of 10³ Pa-s (e.g., based on an approximate shear rate of 100 s⁻¹ in a hot end with 0.4 mm nozzle), an elastic modulus of 1 GPa is to be provided to prevent buckling. Much lower elastic modulus values are permitted for lower viscosity materials and for use with larger nozzles.

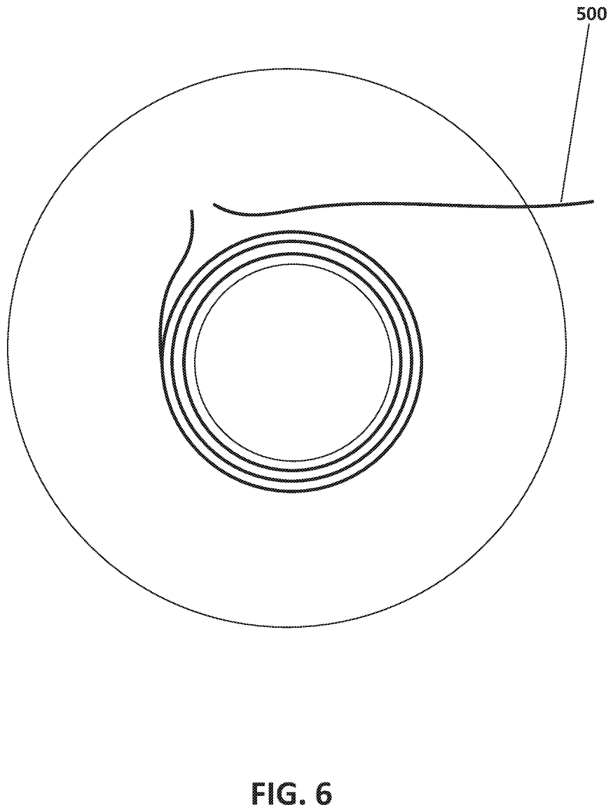

FIG. 5 illustrates the behavior of a filament 500 that is too brittle for 3D printing. The filament 500 breaks at the motor gear 306, also preventing printing. For example, if 50 percent graphite or 40 percent graphite is blended into a PLA, for example, the resulting filament may be stiff and break when wrapped on a filament spool or during the printing process.

A minimum tensile strength may also be targeted for the composite material. A minimum tensile strength to prevent breaking during spooling is:

$$σ = \frac{EI}{ρ S} = \frac{Ed}{2 {R}_{o} + d} \qquad ( 5 )$$

where σ is the tensile strength, E is the elastic modulus, I is the moment of inertia, p is the radius of curvature, S is the section modulus for a circular cross section, d is the filament diameter, and Rₒ is the radius of the spool (e.g., circle around which the filament is wrapped). Equation 5 may be rearranged to provide the necessary ratio tensile strength to elastic modulus for any filament material:

$$\frac{σ}{E} = \frac{d}{2 {R}_{o} + d} \qquad ( 6 )$$

For a filament diameter of 1.75 mm and a spool radius of 40 mm, σ/E=0.034. Using E=2 GPa from the buckling equation above, the filament (e.g., composite material) is to have a minimum tensile strength of 43 MPa to prevent breaking during spooling. Adding a factor of safety, the ratio of tensile strength to elastic modulus is to be greater than 0.04 to prevent filament breaking. FIG. 6 illustrates the behavior of the filament 500, for example, when the filament 500 is too brittle for spooling, causing breakage of the filament 500. The breakage during spooling may also be caused by an insufficient bend radius.

The use of a soft and flexible polymer matrix (e.g., the soft/flexible thermoplastic matrix 106) allows for a higher concentration of thermally conductive fillers (e.g., the thermally conductive filler particles 104) without creating a brittle filament. Typical concentrations of fillers in commercial 3D printing filaments is 20 percentage by weight. Composite materials of the present embodiments may have a concentration of fillers of up to 85 percentage by weight. This high concentration of fillers is important for thermal conductivity. In some cases, this will allow the filler concentration to be high enough to reach percolation (i.e., the filler particles are connected within the material to create conductive pathways) to achieve high thermal conductivity.

The addition of a second bulk polymer that is polar (e.g., the polar thermoplastic 108) interacts stronger with certain filler particles such as, for example, graphite and boron nitride (e.g., functionalized graphite or boron nitride), enabling more complete wetting between the polymer matrix and the filler particles. Better wetting results in fewer voids in the composite material (e.g., within the pellets, the filament, and the resultant 3D printed part). This leads to high thermal conductivity, strength, and toughness. Increasing the polarity of the filament also leads to stronger adhesion to polar surfaces when printing (e.g., glass is one of the most common printing surfaces and is polar).

Forming the thermally conductive polymer based pellets 102 includes acts 110-118. In act 110, solid forms of the thermally conductive filler particles 104, the thermoplastic matrix 106, and the polar thermoplastic 108 are mixed. For example, solid forms of the thermally conductive filler particles 104, the thermoplastic matrix 106, and the polar thermoplastic 108 are mixed in a hopper or another device for mixing, producing a solid mixture.

In act 112, heat is applied to the solid mixture. Heat is applied to the solid mixture to raise the solid mixture to a temperature at or above a highest melting temperature of the one or more types of thermoplastic matrix and the one or more types of polar thermoplastics. The heat applied in act 112 melts the thermoplastic matrix 106 and the polar thermoplastic 108 (e.g., a melted mixture), while the thermally conductive filler particles 104 remain solid. In one embodiment, the heat is applied to the solid mixture using heated screws. Other devices for heat application to melt the solid mixture may be used.

In act 114, the melted mixture 106, 108 is mixed with the thermally conductive filler particles 104. The melted mixture 106, 108 may be mixed with the thermally conductive filler particles 104 in any number of ways including, for example, with the heated screws used on act 112 or other heated screws.

In act 116, a solid piece of the composite material is formed. The forming of the solid piece of the composite material includes cooling and solidifying the mixture of act 114, including the melted mixture 106, 108 and the solid thermally conductive filler particles 104. The mixture of act 114 may be cooled and solidified in any number of ways including, for example, through conduction, convection, and radiation away from the mixture, positioned within a die. In other embodiments, active cooling may be used to cool and solidify the mixture of act 114.

In act 118, the cooled and solidified mixture of act 116 is pelletized using, for example, a pelletizer. The pelletizer, for example, cuts the solid piece of the composite material formed in act 116 into the pellets.

In act 120, an additive manufacturing (e.g., 3D printing) filament is manufactured. Manufacturing the additive manufacturing filament includes acts 122-126. In act 122, the pellets formed in acts 110-118 are melted. Heat is applied in act 122 to melt the thermoplastic matrix 106, the polar thermoplastic 108, and the thermally conductive filler particles 104 included within the pellets. In other words, heat is applied to the pellets such that the pellets reach a temperature at or above a highest melting temperature of the thermoplastic matrix 106 and the polar thermoplastic 108 included within the pellets. In one embodiment, heat is applied to the pellets such that the pellets reach a temperature at or above a highest melting temperature of the thermoplastic matrix 106, the polar thermoplastic 108, and the thermally conductive filler particles 104. If one or more of the thermoplastics in the composition are amorphous and do not have a melting temperature, the temperature is raised to a sufficient level to allow the polymer to flow and mix with the other components. In one embodiment, the heat is applied to the pellets using heated screws. Other devices for heat application to melt the solid mixture may be used.

In act 124, the thermally conductive polymer based additive manufacturing filament (e.g., monofilament) is extruded from the melted pellets of act 122 via a die. During the extrusion, the melted composite material (e.g., from the melted pellets) is cooled and solidified within the die (e.g., via conduction, convection, and radiation of heat away from the die), forming a solid filament 128. A size (e.g., a diameter) of the die sets a size (e.g., a diameter) of the filament. Different sized dies may be used to manufacture different sized filaments (e.g., a monofilament with a predetermined diameter). Common filament diameters used for FDM 3D printing are 1.75 mm and 2.85 mm, but other filament diameters may be provided. In act 126, the solid filament formed in act 124 is collected on a spool.

In one embodiment, the method 100 does not include at least acts 116-120. For example, the thermally conductive polymer based additive manufacturing filament is extruded directly from a compounder/mixer used in, for example, act 112 and/or act 114.

In one example, the filament 128 may include a thermoplastic elastomer including, for example, TPU, a biopolymer including, for example, PLA, and a filler of graphite powder. A 3D printed part using such a filament 128 may exhibit thermal conductivity up to, for example, 15 W/m-K in a direction of printing. For example, a possible composite material to achieve greater than 7 W/m-K in a printed part, and a filament that may be printed with bed adhesion, is flexible to avoid breaking during spooling and printing, and may be printed on a common FDM 3D printer is a material composition of 56 weight percentage (e.g., relative to a total weight of the composite material) high purity graphite powder, 35 weight percentage (e.g., relative to a total weight of the composite material) Shore 95A hardness TPU, and 9 weight percentage (e.g., relative to a total weight of the composite material) PLA. Other combinations may be provided.

In another example, the filament 128 may include a thermoplastic polymer including, for example, Nylon, an additional functional additive including, for example, an organic flame retardant, and a filler of, for example, graphite flakes. A 3D printed part using such a filament 128 may, for example, exhibit thermal conductivity of 4 W/m-K or more in a direction of printing, an elastic modulus of 4 GPa, and a notched impact strength of 50 J/m. For example, a possible composite material to achieve 4 W/m-K or more in a printed part, and a filament that may be printed with bed adhesion, is flexible to avoid breaking during spooling and printing, and may be printed on a common FDM 3D printer is a material composition of 30 weight percentage (e.g., relative to a total weight of the composite material) graphite flakes, 60 weight percentage (e.g., relative to a total weight of the composite material) Nylon 6,6 with an elastic modulus of 1.7 GPa and a notched impact strength of 500 J/m, and 10 weight percentage (e.g., relative to a total weight of the composite material) of an organic flame retardant. Other combinations may be provided.

In yet another example, the filament 128 may include a thermoplastic elastomer including, for example, thermoplastic polyurethane, a polar thermoplastic polymer including, for example, polycarbonate, and a filler of, for example, graphite flakes. A 3D printed part using such a filament 128 may, for example, exhibit thermal conductivity of 10 W/m-K or more in a direction of printing and a notched impact strength of 400 J/m. For example, a possible composite material to achieve 10 W/m-K or more in a printed part, and a filament that may be printed with bed adhesion, is flexible to avoid breaking during spooling and printing, and may be printed on a common FDM 3D printer is a material composition of 50 weight percentage (e.g., relative to a total weight of the composite material) graphite flakes, 40 weight percentage (e.g., relative to a total weight of the composite material) thermoplastic polyurethane with a Shore hardness of 80A, and 10 weight percentage (e.g., relative to a total weight of the composite material) of a polycarbonate with an elastic modulus of 2.3 GPa and a notched impact strength of 320 J/m. Other combinations may be provided.

In another example, the filament 128 may include a thermoplastic elastomer including, for example, thermoplastic polyurethane, a polar thermoplastic polymer including, for example, polycarbonate, a first filler of, for example, boron nitride flakes, and a second filler of, for example, boron nitride nanotubes. A 3D printed part using such a filament 128 may, for example, exhibit thermal conductivity of 5 W/m-K or more in a direction of printing and a notched impact strength of 400 J/m. For example, a possible composite material to achieve 5 W/m-K or more in a printed part, and a filament that may be printed with bed adhesion, is flexible to avoid breaking during spooling and printing, and may be printed on a common FDM 3D printer is a material composition of 30 weight percentage (e.g., relative to a total weight of the composite material) boron nitride flakes, 10 weight percentage (e.g., relative to a total weight of the composite material) boron nitride nanotubes, 50 weight percentage (e.g., relative to a total weight of the composite material) thermoplastic polyurethane with a Shore hardness of 95A, and 10 weight percentage (e.g., relative to a total weight of the composite material) of a polycarbonate with an elastic modulus of 2.3 GPa and a notched impact strength of 320 J/m. Other combinations may be provided.

In another example, the filament 128 may include a thermoplastic polymer including, for example, poly(butylene terephthalate), a thermoplastic elastomer, and a filler of, for example, pitch-based carbon fibers. A 3D printed part using such a filament 128 may, for example, exhibit thermal conductivity of 6 W/m-K or more in a direction of printing, an elastic modulus of 2 GPa, and a notched impact strength of 180 J/m. For example, a possible composite material to achieve 6 W/m-K or more in a printed part, and a filament that may be printed with bed adhesion, is flexible to avoid breaking during spooling and printing, and may be printed on a common FDM 3D printer is a material composition of 25 weight percentage (e.g., relative to a total weight of the composite material) pitch-based carbon fibers, 60 weight percentage (e.g., relative to a total weight of the composite material) poly(butylene terephthalate), and 15 weight percentage (e.g., relative to a total weight of the composite material) of a thermoplastic elastomer. Properties for a combination of the thermoplastic polymer and the thermoplastic elastomer may, for example, be an elastic modulus of 0.7 GPa and a notched impact strength of 330 J/m. Other combinations may be provided.

The thermal conductivity of a printed sample may be measured using laser flash (ASTM E1461). A 12 mm cube can be FDM printed using a 0.8 mm nozzle, 0.4 mm layer height, and 0 and 90° alternating infill. The cube may then be cut and sanded into a 10×10×1 mm box such that the print lines are normal to the 10×10 mm face of the sample, thus allowing measurement of in-plane or in the print direction thermal conductivity. The thermal conductivity may be extracted from the laser flash thermal diffusivity measurement using either a calibrated laser flash sample or through independent measurement of the density and specific heat of the sample.

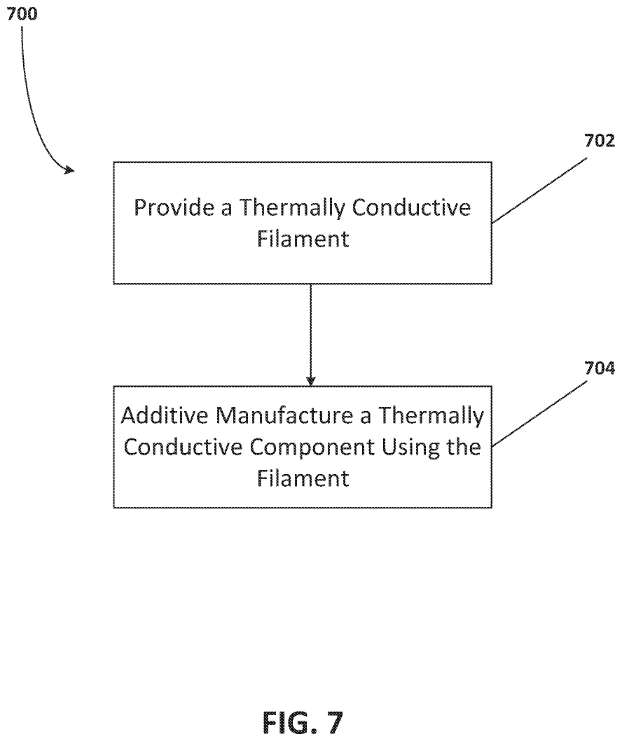

FIG. 7 shows a flowchart of one example of a method 700 for manufacturing a thermally conductive component. The method 700 is implemented in the order shown, but other orders may be used. Additional, different, or fewer acts may be provided. Similar methods may be used for manufacturing a thermally conductive component.

In act 702, a thermally conductive filament is provided. The thermally conductive filament may be a filament manufactured using the method 100 or another method. The thermally conductive filament may be made of any number compositions. For example, the thermally conductive filament may be made of a composition including from 15 to 80 weight percentage (e.g., 40 to 75 weight percentage) of a thermoplastic polymer, a thermoplastic elastomer, or a combination thereof. The thermoplastic polymer, the thermoplastic elastomer, or the combination thereof has a Notched Izod impact strength greater than or equal to 300 J/m and a flexural modulus less than 3 GPa. The composition also includes from 20 to 85 weight percentage (e.g., 25 to 50 weight percentage) of a thermally conductive filler with an intrinsic thermal conductivity greater than or equal to 1 W/m-K. The thermally conductive filler includes aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic-coated graphite, expanded graphite, carbon black, carbon fibers, carbon nanotubes, graphene, metal wires, or any combination thereof. The composition includes from 0 to 25 weight percentage (e.g., a non-zero weight percentage less than or equal to 25 weight percentage; 10 to 20 weight percentage) of a polar thermoplastic polymer having polarity on a main chain of a molecule that results in a dipole moment. In one embodiment, the composition does not include the polar thermoplastic polymer.

The composition is, for example, characterized by a thermal conductivity of at least 0.75 W/m-K and a Notched Izod impact strength of at least 100 J/m. Other compositions may be used. In one embodiment, a combination of the thermoplastic polymer, the thermoplastic elastomer, or the combination thereof, and the polar thermoplastic polymer has a Notched Izod impact strength greater than or equal to 300 J/m and a flexural modulus less than 3 GPa.

In act 704, the thermally conductive component is additive manufactured using the thermally conductive filament provided in act 702. The thermally conductive component may be additive manufactured in any number of ways including, for example, by 3D printing using the thermally conductive filament provided in act 702. Other types of additive manufacturing may be used to produce the thermally conductive component.

In one embodiment, additive manufacturing the thermally conductive component includes 3D printing the thermally conductive component directly onto a thermally conductive substrate. For example, the thermally conductive component may be additive manufactured directly onto a metal substrate. In other embodiments, the thermally conductive component is additive manufactured directly onto substrates of other materials.

In one embodiment, the thermally conductive component is a component for a computing device. For example, the thermally conductive component is at least a part of a thermal management device for the computing device. The thermally conductive component may be any number of different types of components including, for example, a heat sink, a heat pipe, a vapor chamber, a heat spreader, or another type of component.

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

In a first embodiment, a composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a polar thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The thermally conductive filler includes aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic-coated graphite, expanded graphite, carbon fibers, carbon nanotubes, graphene, metal wires, or any combination thereof. The composition is characterized by a thermal conductivity of at least 0.75 W/m-K.

In a second embodiment, with reference to the first embodiment, the thermally conductive filler includes carbon black.

In a third embodiment, with reference to the first embodiment, a combination of the thermoplastic polymer and the polar thermoplastic polymer has a Notched Izod impact strength greater than or equal to 300 J/m and a flexural modulus less than 3 GPa.

In a fourth embodiment, with reference to the first embodiment, the thermoplastic polymer includes an aliphatic polyamide, polystyrene, polyester, polypropylene, polyphenylene sulfide, polycarbonate, polyolefin, polyurethane, polyetherimide, or any combination thereof.

In a fifth embodiment, with reference to the first embodiment, the thermoplastic polymer includes a polyamide, polyester, polyphenylene sulfide, polycarbonate, polyolefin, polyurethane, polyetherimide, poly(methyl methacrylate), acrylonitrile butadiene styrene, acrylic styrene acrylonitrile, polyaryletherketone, liquid crystal polymer or any combination thereof.

In a sixth embodiment, with reference to the first embodiment, the thermoplastic polymer includes a polyamide, polyester, polyphenylene sulfide, polycarbonate, polyolefin, polyurethane, polyetherimide, poly(methyl methacrylate), acrylonitrile butadiene styrene, acrylic styrene acrylonitrile, polyaryletherketone, liquid crystal polymer or any combination thereof.

In a seventh embodiment, with reference to the first embodiment, the 15 to 80 weight percentage of the thermoplastic polymer, the thermoplastic elastomer, or the combination thereof includes the thermoplastic elastomer. The thermoplastic elastomer includes styrenic block copolymers, olefins, elastomeric alloys, polyurethanes, copolyesters, polyamides, or any combination thereof.

In an eighth embodiment, with reference to the first embodiment, the 15 to 80 weight percentage of the thermoplastic polymer, the thermoplastic elastomer, or the combination thereof includes the thermoplastic elastomer. The thermoplastic elastomer includes polyurethanes, copolyesters, olefins, styrenic block copolymers, elastomeric alloys, polyamides, or any combination thereof.

In a ninth embodiment, with reference to the first embodiment, the composition further includes 0 to 15 weight percentage of additional functional additives, the additional functional additives including flame retardants, reinforcing fibers, plasticizers, compatiblizers, or any combination thereof.

In a tenth embodiment, with reference to the first embodiment, the thermally conductive filler has a maximum dimension less than or equal to 0.3 mm.

In an eleventh embodiment, with reference to the first embodiment, the thermally conductive filler has a size exceeding 0.3 mm only in one direction.

In a twelfth embodiment, with reference to the first embodiment, the composition is characterized by a tensile strength that is greater than or equal to 0.04 times the elastic modulus.

In a thirteenth embodiment, with reference to the first embodiment, the composition is characterized by a Notched Izod impact strength greater than or equal to 100 J/m.

In a fourteenth embodiment, with reference to the first embodiment, the thermally conductive filler includes thermally conductive polymer particles, thermally conductive polymer fibers, thermally conductive polymer flakes, carbon fibers, carbon nanotubes, graphitic flakes, BN nanotubes, BN flakes, metal wires, or any combination thereof.

In a fifteenth embodiment, with reference to the fourteenth embodiment, the thermally conductive filler is a thermally conductive polymer particle, a thermally conductive polymer fiber, a thermally conductive polymer flake, a carbon fiber, a carbon nanotube, a graphite flake, a BN nanotube, a BN flake, or a metal wire.

In a sixteenth embodiment, with reference to the fourteenth embodiment, the thermally conductive filler is an AlN spherule, a polymer fiber, an SiC particle, a BN flake, a BN nanotube, a graphite flake, an expanded graphite particle, a carbon black particle, a carbon fiber, a carbon nanotube, a graphene nanoplatelet, a metal spherule, or a metal wire.

In a seventeenth embodiment, a method for manufacturing a thermally conductive filament includes forming thermally conductive polymer based pellets, melting the thermally conductive polymer based pellets, and extruding the melted thermally conductive polymer based pellets to a predetermined diameter. The thermally conductive polymer based pellets include a polar thermoplastic, a thermoplastic matrix, and a thermally conductive filler.

In an eighteenth embodiment, with reference to the seventeenth embodiment, extruding the melted thermally conductive polymer-based pellets to a predetermined diameter comprises extruding the melted thermally conductive polymer-based pellets into a monofilament of a predetermined diameter.

In a nineteenth embodiment, with reference to the seventeenth embodiment, forming the thermally conductive polymer-based pellets includes mixing the polar thermoplastic, the thermoplastic matrix, and thermally conductive filler, melting the polar thermoplastic and the thermoplastic matrix, forming a solid piece of composite material, and pelletizing the solid piece of composite material. The forming of the solid piece of composite material includes mixing the melted polar thermoplastic, the melted thermoplastic matrix, and thermally conductive filler. The forming of the solid piece of composite material also includes cooling the mixed melted polar thermoplastic, melted thermoplastic matrix, and thermally conductive filler.

In a twentieth embodiment, with reference to the seventeenth embodiment, pelletizing the solid piece of composite material includes cutting pellets from the solid piece of composite material.

In a twenty-first embodiment, with reference to the seventeenth embodiment, the polar thermoplastic has polarity on a main chain of a molecule that results in a dipole moment.

In a twenty-second embodiment, with reference to the seventeenth embodiment, the thermoplastic matrix has a Notched Izod impact strength greater than or equal to 300 J/m and a flexural modulus less than 3 GPa.

In a twenty-third embodiment, with reference to the seventeenth embodiment, the thermally conductive filler has an intrinsic thermal conductivity greater than or equal to 1 W/m-K.

In a twenty-fourth embodiment, with reference to the seventeenth embodiment, the thermally conductive filler includes AlN, BN, BN nanotubes, thermally conductive polymer particles, thermally conductive polymer fibers, MgSiN2, SiC, graphite, ceramic-coated graphite, expanded graphite, carbon nanotubes, graphene, or any combination thereof.

In a twenty-fifth embodiment, with reference to the seventeenth embodiment, the thermally conductive filler includes carbon black, carbon fibers, metal particles, metal wires, or any combination thereof.

In a twenty-sixth embodiment, a method for manufacturing a thermally conductive component includes additive manufacturing the thermally conductive component using a thermally conductive filament. The thermally conductive filament is made of a composition. The composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The composition is characterized by a thermal conductivity of at least 0.75 W/m-K.

In a twenty-seventh embodiment, with reference to the twenty-sixth embodiment, the thermally conductive filler includes aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic coated graphite, expanded graphite, carbon fibers, carbon nanotubes, graphene, metal wires, or any combination thereof.

In a twenty-eighth embodiment, with reference to the twenty-sixth embodiment, the composition is characterized by an Izod notched impact strength of at least 100 J/m.

In a twenty-ninth embodiment, with reference to the twenty-sixth embodiment, the thermally conductive filler includes aluminum nitride (AlN), boron nitride (BN), BN nanotubes, thermally conductive polymer fibers, silicon carbide (SiC), graphite, ceramic-coated graphite, expanded graphite, carbon black, carbon fibers, carbon nanotubes, graphene, metal wires, or any combination thereof.

In a thirtieth embodiment, with reference to the twenty-sixth embodiment, the thermally conductive component is a thermal management device for a computing device.

In a thirty-first embodiment, with reference to the twenty-sixth embodiment, additive manufacturing the thermally conductive component includes three-dimensionally (3D) printing the thermally conductive component using the thermally conductive filament.

In a thirty-second embodiment, with reference to the thirty-first embodiment, 3D printing the thermally conductive component includes 3D printing the thermally conductive component directly onto a thermally conductive substrate.

In a thirty-third embodiment, with reference to the thirty-second embodiment, 3D printing the thermally conductive component directly onto a thermally conductive substrate includes 3D printing the thermally conductive component directly onto a metal substrate.

In a thirty-fourth embodiment, a thermally conductive additive manufacturing filament includes a composition. The composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a thermoplastic polymer having polarity on a main chain of a molecule that results in a dipole moment. The thermoplastic polymer, the thermoplastic elastomer, or the combination thereof has a Notched Izod impact strength greater than or equal to 300 J/m and a flexural modulus less than 3 GPa. The thermally conductive filler includes aluminum nitride (AlN), boron nitride (BN), BN nanotubes, thermally conductive polymer fibers, silicon carbide (SiC), graphite, ceramic-coated graphite, expanded graphite, carbon black, carbon fibers, carbon nanotubes, graphene, metal wires, or any combination thereof. The composition is characterized by a thermal conductivity of at least 0.75 W/m-K.

In a thirty-fifth embodiment, a thermally conductive additive manufacturing filament includes a composition. The composition includes from 15 to 80 weight percentage of a thermoplastic polymer, a thermoplastic elastomer, or a combination thereof, from 20 to 85 weight percentage of a thermally conductive filler with an intrinsic thermal conductivity greater than or equal to 1 W/m-K, and from 0 to 25 weight percentage of a thermoplastic polymer having polarity on a main chain of a molecule that results in a dipole moment. The thermoplastic polymer, the thermoplastic elastomer, or the combination thereof has a Notched Izod impact strength greater than or equal to 0.3 kJ/m and a flexural modulus less than 3 GPa. The thermally conductive filler includes aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic-coated graphite, expanded graphite, carbon fibers, carbon nanotubes, graphene, metal wires, or any combination thereof. The composition is characterized by a thermal conductivity of at least 0.75 W/m-K.

In a thirty-sixth embodiment, with reference to the thirty-fifth embodiment, the composition is characterized by an Izod notched impact strength of at least 100 J/m.

In a thirty-seventh embodiment, with reference to the thirty-fifth embodiment, the composition is further characterized by a minimum bending radius of less than or equal to 30 mm when extruded into a 1.75 mm diameter monofilament, and adhesion to a polar substrate when the composition is deposited above a glass transition of the thermoplastic polymer having polarity on the main chain of the molecule that results in a dipole moment.

In a thirty-eighth embodiment, with reference to the thirty-fifth embodiment, a longest axis of the thermally conductive filler is aligned along a longest axis of the thermally conductive additive manufacturing filament.

In connection with any one of the aforementioned embodiments, the composition, the method for manufacturing a thermally conductive filament, the method for manufacturing a thermally conductive component, or the thermally conductive additive manufacturing filament may alternatively or additionally include any combination of one or more of the previous embodiments.

The foregoing description is given for clearness of understanding only, and no unnecessary limitations should be understood therefrom, as modifications within the scope of the claims may be apparent to those having ordinary skill in the art.

1. A composition comprising:
a. from 15 to 80 weight percentage of a thermoplastic polymer, a thermoplastic elastomer, or a combination thereof, the thermoplastic polymer, the thermoplastic elastomer, or the combination thereof having a Notched Izod impact strength greater than or equal to 300 J/m and a flexural modulus less than 3 GPa; and
b. from 20 to 85 weight percentage of a thermally conductive filler with an intrinsic thermal conductivity greater than or equal to 1 W/m-K, the thermally conductive filler including aluminum nitride (AlN), boron nitride (BN), BN nanotubes, thermally conductive polymer particles, thermally conductive polymer fibers, thermally conductive flakes, MgSiN2, silicon carbide (SiC), graphite, ceramic-coated graphite, expanded graphite, carbon fibers, carbon nanotubes, graphene, metal wires, or any combination thereof,
wherein the composition is characterized by a thermal conductivity of at least 0.75 W/m-K.

2. The composition of claim 1, further comprising:
c. less than or equal to 25 weight percentage of a polar thermoplastic polymer having polarity on a main chain of a molecule that results in a dipole moment.

3. The composition of claim 1, wherein a combination of the thermoplastic polymer and the polar thermoplastic polymer has a Notched Izod impact strength greater than or equal to 300 J/m and a flexural modulus less than 3 GPa.

4. The composition of claim 1, wherein the thermoplastic polymer includes an aliphatic polyamide, polystyrene, polyester, polypropylene, polyphenylene sulfide, polycarbonate, polyolefin, polyurethane, polyetherimide, or any combination thereof.

5. The composition of claim 1, wherein the polar thermoplastic polymer includes a polyamide, polycarbonate, acrylonitrile butadiene styrene, acrylic styrene acrylonitrile, poly(methyl methacrylate), polyester, polylactic acid, thermoplastic elastomer, or any combination thereof.

6. The composition of claim 1, wherein the 15 to 80 weight percentage of the thermoplastic polymer, the thermoplastic elastomer, or the combination thereof includes the thermoplastic elastomer, and
wherein the thermoplastic elastomer includes polyurethanes, copolyesters, olefins, styrenic block copolymers, elastomeric alloys, polyamides, or any combination thereof.

7. The composition of claim 1, further comprising 0 to 15 weight percentage of additional functional additives, the additional functional additives including organic flame retardant, reinforcing fibers, plasticizers, compatiblizers, or any combination thereof.

8. The composition of claim 1, wherein the thermally conductive filler has a size exceeding 0.3 mm only in one direction.

9. The composition of claim 1, wherein the composition is characterized by a Notched Izod impact strength greater than or equal to 100 J/m.

10. The composition of claim 1, wherein the thermally conductive filler is an AlN spherule, a polymer fiber, an SiC particle, a BN flake, a BN nanotube, a graphite flake, an expanded graphite particle, a carbon black particle, a carbon fiber, a carbon nanotube, a graphene nanoplatelet, a metal spherule, or a metal wire.

11. A method for manufacturing a thermally conductive filament, the method comprising:
forming thermally conductive polymer-based pellets, the thermally conductive polymer-based pellets including a polar thermoplastic, a thermoplastic matrix, and a thermally conductive filler;
melting the thermally conductive polymer-based pellets; and
extruding the melted thermally conductive polymer-based pellets to a predetermined diameter.

12. The method of claim 11, wherein extruding the melted thermally conductive polymer-based pellets to a predetermined diameter comprises extruding the melted thermally conductive polymer-based pellets into a monofilament of a predetermined diameter.

13. The method of claim 11, wherein forming the thermally conductive polymer-based pellets includes:
mixing the polar thermoplastic, the thermoplastic matrix, and the thermally conductive filler;
melting the polar thermoplastic and the thermoplastic matrix;
forming a solid piece of composite material, the forming of the solid piece of composite material including:
mixing the melted polar thermoplastic, the melted thermoplastic matrix, and the thermally conductive filler; and
cooling the mixed melted polar thermoplastic, melted thermoplastic matrix, and thermally conductive filler; and
pelletizing the solid piece of composite material.

14. The method of claim 11, wherein the polar thermoplastic has polarity on a main chain of a molecule that results in a dipole moment.

15. The method of claim 11, wherein the thermoplastic matrix has a Notched Izod impact strength greater than or equal to 300 J/m and a flexural modulus less than 3 GPa.

16. The method of claim 11, wherein the thermally conductive filler has an intrinsic thermal conductivity greater than or equal to 1 W/m-K.

17. The method of claim 11, wherein the thermally conductive filler includes AlN, BN, BN nanotubes, thermally conductive polymer particles, thermally conductive polymer fibers, MgSiN2, SiC, graphite, ceramic-coated graphite, expanded graphite, carbon nanotubes, graphene, or any combination thereof.

18. The method of claim 11, wherein the thermally conductive filler includes carbon black, carbon fibers, metal particles, metal wires, or any combination thereof.

19. A thermally conductive additive manufacturing filament comprising:
a composition comprising:
a. from 15 to 80 weight percentage of a thermoplastic polymer, a thermoplastic elastomer, or a combination thereof, the thermoplastic polymer, the thermoplastic elastomer, or the combination thereof having a Notched Izod impact strength greater than or equal to 0.3 kJ/m and a flexural modulus less than 3 GPa; and
b. from 20 to 85 weight percentage of a thermally conductive filler with an intrinsic thermal conductivity greater than or equal to 1 W/m-K, the thermally conductive filler including aluminum nitride (AlN), boron nitride (BN), BN nanotubes, thermally conductive polymer fibers, silicon carbide (SiC), graphite, ceramic-coated graphite, expanded graphite, carbon black, carbon fibers, carbon nanotubes, graphene, metal wires, or any combination thereof,
wherein the composition is characterized by a thermal conductivity of at least 0.75 W/m-K.

20. The thermally conductive additive manufacturing filament of claim 19, wherein the composition further comprises:
c. less than or equal to 25 weight percentage of a thermoplastic polymer having polarity on a main chain of a molecule that results in a dipole moment.

21. The thermally conductive additive manufacturing filament of claim 19, wherein the composition is further characterized by:
a minimum bending radius of less than or equal to 30 mm when the thermally conductive additive manufacturing filament is a 1.75 mm diameter monofilament; and
adhesion to a polar substrate when the composition is deposited above a glass transition of the thermoplastic polymer having polarity on the main chain of the molecule that results in a dipole moment.
